(19) United States
(12) Patent Application Publication
(10) Pub. No.: US 2007/0215575 A1
(43) Pub. Date: Sep. 20, 2007

(54) Method and system for high-speed, precise, laser-based modification of one or more electrical elements

(76) Inventors: Bo Gu, North Andover, MA (US); Donald J. Svetkoff, Ann Arbor, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/708,918

(22) Filed: Feb. 21, 2007

Related U.S. Application Data
(63) Continuation-in-part of application No. 11/376,527, filed on Mar. 15, 2006.

(51) Int. Cl. G01L 21/30; B44C 1/22

(52) U.S. Cl. 216/59; 216/65; 216/94; 216/60; 156/345.24

(57) ABSTRACT

A method and system for high-speed, precise, laser-based modification of at least one electrical element made of a target material is provided. The system includes a laser subsystem that generates a pulsed laser output wherein each laser pulse has a pulse energy, a laser wavelength within a range of ablation sensitivity of the target material, and a pulse duration short enough to substantially reduce ablation threshold energy density of the target material. The system further includes a beam positioner that selectively irradiates the at least one electrical element with the one or more laser pulses focused into at least one spot so as to cause the one or more laser pulses to selectively ablate a portion of the target material from the at least one element while avoiding both substantial spurious opto-electric effects and undesirable damage to the non-target material.

### CROSS REFERENCE TO RELATED APPLICATION

This application is a continuation-in-part application of published U.S. Patent Application 2006/0199354 (the '9354 publication), entitled “Method and System for Precise Laser Trimming and Device Produced Thereby,” assigned to the assignee of the present invention and hereby incorporated by reference in its entirety. The '9354 publication discloses numerous characteristics of a laser used for trimming, particularly for trimming thin-film resistors on various substrates, including ceramic substrates. A typical laser is q-switched, with operation in the range of up to 100 KHz. Laser parameters may include 100 nanosecond (ns) pulse widths with about 100 microjoules (μJ) in each pulse. The '9354 publication also discloses various non-conventional laser subsystems for use in trimming, for instance MOPA fiber configurations and ultrashort lasers.

### BACKGROUND OF THE INVENTION

1. Field of the Invention

The invention generally relates to laser material processing, for instance laser-based micromachining. Embodiments of the invention are particularly directed to modification of one or more materials from a multimaterial device without causing performance drifting or malfunction of certain types of devices, for instance active electronic devices. Certain embodiments relate to laser trimming, tuning, or other adjustment of integrated circuits or other electrical elements using ultrashort lasers.

2. Background Art

Problems associated with “functional processing” are well documented as disclosed in Japanese Publication JP S62-160726 (Fujiwara '726 patent publication) and U.S. Pat. Nos. 5,685,995 (the '995 patent) and 5,808,272 (the '272 patent). The solutions generally involve operating semiconductor material processing equipment, for instance a laser used for functional trimming, at a wavelength corresponding to low absorption and quantum efficiency. Reference is made to the disclosures of the '726 patent publication, and the '995 and '272 patents, portions of which are incorporated herein. Several aspects of laser trimming are discussed in the “LIA Handbook of Laser Material Processing” (hereinafter “Handbook”), 2002, Chapter 17, “Trimming,” pages 583-588.

FIG. 1a is a plan view of a portion of a prior art integrated circuit depicting resistors having a patterned resistor path between metal contacts. The resistive value of a resistor is largely a function of the pattern geometry, the path length between the contacts and the thickness of material composing resistor. An “L-cut” on one of the resistors depicts a typical laser-induced modification. In the L-cut, a first strip of resistive material is removed in a direction perpendicular to a line between the contacts to make a coarse adjustment to the resistance value. Then an adjoining second strip, perpendicular to the first strip, may be removed to make a finer adjustment to the resistance value. A “serpentine cut” on the other resistor depicts another common type or laser adjustment. In a serpentine cut, resistor material is removed along lines to increase the length of a path. Lines are added until a desired resistive value is reached.

U.S. Pat. No. 4,399,345 to Lapham (assigned to Analog Devices) teaches that integrated-circuit components commonly comprise a semiconductor substrate, typically doped Silicon, carrying a combination of active and/or passive circuit elements. In many cases, such circuit elements include thin films of electrically-conductive material forming electrical resistors, and separated from the substrate by dielectric material. Lapham disclosed that trimming is effected by a laser selected and/or adjusted to have a wavelength sufficiently high that the photon energy in the beam it emits will be less than the band-gap energy level of the doped semiconductive substrate material. Expressing this relationship in another way, the laser beam frequency should be less than E_{g}/h, where E_{g} is the optical band-gap energy of the doped substrate, and “h” is Planck's constant. The result is a much reduced level of energy adsorption in the substrate, so that higher-powered laser beams can be used for trimming.

FIG. 1b is a block diagram of a prior art activated dynamic-trim system and device. FIG. 1c is a simplified schematic diagram of a multiplier cell wherein FIGS. 1b and 1c correspond to FIGS. 3 and 4, respectively, of chapter 3 the Handbook entitled “Nonlinear Circuits Handbook” published by Analog Devices Inc. in 1976. The reference discloses, in a pertinent part: FIG. 4 is a simplified schematic of a multiplier cell. In normal operation, a constant voltage is applied at the −X input to adjust the offset of the X-input transistor pair. In dynamic trimming, the X inputs are held at zero volts (so is the −Y input), while the +Y input is switched between a specified voltage-pair. The laser then increases the resistance of either R1 or R2, which adjusts the current balance in the stage for minimum linear feedthrough. This is measured by phase-sensitive chopping and filtering of the device's output; the laser is turned off when the output of the filter is zero, indicating equal feedthrough at both input levels. The feedthrough for the +X input is adjusted in a similar manner by holding the Y inputs and −X at zero and increasing the resistance of either R3 or R4. Once the device has been plugged in and aligned to the X-Y table the trim procedure is completely automatic. The authors also note that the result is an integrated-circuit multiplier which can be plugged in and turned on, with no adjustments, or external components required.

Functional processing is further described in detail by R. H. Wagner, “Functional Laser Trimming: An Overview,” PROCEEDINGS OF SPIE, Vol. 611, January 1986, at 12-13; and M. J. Mueller and W; Mickanin, “Functional Laser Trimming of Thin Film Resistors on Silicon ICs,” PROCEEDINGS OF SPIE, Vol. 611, January 1986, at 70-83.

Despite the prior art, there is still a need to further improve laser trimming processes, for instance trimming state-of-the-art active devices on silicon or other semiconductor substrates.

### SUMMARY OF THE INVENTION

It is, therefore, desirable to have a new laser trimming technology that would allow smaller laser spot size while also reducing the photoelectric response and avoiding undesirable substrate damage.

An object of at least one embodiment of the present invention is to allow faster functional laser processing, ease geometric restrictions on circuit design, and facilitate production of denser and smaller devices.

In carrying out the above object and other objects of the present invention, a method of high-speed, precise, laser-based modification of at least one electrical element to adjust a measurable parameter is provided. The at least one electrical element comprises a target material and is supported on a substrate. The method includes generating a pulsed laser output having one or more laser pulses at a repetition rate. Each laser pulse has a pulse energy, a laser wavelength, and at least one temporal characteristic that sufficiently reduces an ablation threshold energy density of the target material to avoid both substantial spurious opto-electric effects in a non-target material and undesirable damage to the non-target material. The method further includes selectively irradiating the at least one electrical element with the one or more laser pulses focused into at least one spot so as to cause the one or more laser pulses having the wavelength, energy and the at least one temporal characteristic to selectively modify a physical property of the target material of the at least one electrical element while avoiding both the substantial spurious opto-electric effects in the non-target material and undesirable damage to the non-target material.

The step of irradiating may selectively ablate a portion of the target material and the wavelength may be within a range of ablation sensitivity of at least the target material.

The at least one temporal characteristic may include a pulse duration and the ablation threshold energy density may decrease with reduced pulse duration.

The at least one electrical element may be operatively connected to an electronic device having the measurable parameter. The method may further include activating at least a portion of the device and measuring a value of the measurable parameter either during or after the step of generating.

The at least one temporal characteristic may include a pulse duration of about 25 femtoseconds or greater.

The at least one temporal characteristic may include a substantially square pulse shape, and each laser pulse may have a duration less than about 10 nanoseconds.

The target and non-target material may both be supported on the substrate which is a non-target substrate having a substrate ablation energy density threshold.

Each laser pulse may have a duration greater than 25 femtoseconds and less than about 10 nanoseconds.

The laser-based modification may be laser trimming and the method may further include comparing an actual value of the parameter with a preselected value for the parameter and determining whether the target material requires additional irradiating with the laser output to satisfy the preselected value for the parameter of the device.

The target material may form part of a target structure and the non-target material may comprise a material of the substrate which supports the target structure. The non-target material may include at least one of silicon, germanium, indium gallium arsenide, semiconductor and ceramic material and the target material may include at least one of aluminum, titanium, nickel, copper, tungsten, platinum, gold, nickel, chromide, tantalum nitride, titanium nitride, cesium silicide, doped polysilicon, disilicide, and polycide.

The non-target material may comprise a portion of an electronic structure adjacent the target material.

The adjacent electronic structure may comprise a semiconductor material-based substrate or a ceramic substrate.

The target material may form part of a thin film resistor, a capacitor, an inductor, an integrated circuit, or an active device.

The target material may form part of an active device which may include at least one conductive link, and the device may be adjusted, at least in part, by removing the at least one conductive link by performing the steps of generating and irradiating.

The target material or the non-target material may comprise a portion of a photo-electric sensing component.

The photo-electric sensing component may comprise a photodiode or a CCD.

The device may be an opto-electric device and the target material or the non-target material may comprise a portion of the opto-electric device. The device may include a photo-sensing element and an amplifier operatively coupled to the photo-sensing element, and the laser wavelength may be in a region of high quantum efficiency of the photo-sensing element, whereby the size of the at least one spot may be reducible compared to a spot size produced at a wavelength greater than 1 μm.

The photo-sensing element and the amplifier may be an integrated assembly. The method may further include generating an optical measurement signal and directing the measurement signal along a path having a common portion with a path of the one or more laser pulses.

The step of determining may be performed substantially instantaneously subsequent to the step of irradiating.

There may be substantially no device settling time between the steps of irradiating and measuring.

The at least one electrical element may include one or more elements having substantially different optical properties. The step of generating may be carried out with a master oscillator and power amplifier (MOPA). The master oscillator may include a semiconductor laser diode. The method may further include applying a signal to the laser diode to control the at least one temporal characteristic so as to selectively modify the physical property of the target material.

The at least one temporal characteristic may include a pulse duration. The substrate may be a silicon substrate, the wavelength may be less than 1.6 μm, and the pulse duration may be less than about 100 picoseconds.

The wavelength may be about 1.55 μm, and the step of generating may be at least partially carried out with an Erbium-doped, fiber amplifier and a seed laser diode. Opto-electronic sensitivity may be below a detection limit of equipment which measures an operational parameter associated with the at least one element, whereby the useful dynamic range of a measurement may be limited by the maximum dynamic range of the equipment.

The at least one temporal characteristic may include a pulse duration. The substrate may be a silicon substrate, the wavelength may be less than 800 nm, and the pulse duration may be less than about 100 picoseconds.

The at least one temporal characteristic may include a pulse duration. The substrate may be a silicon substrate, the wavelength may be less than 550 nm, and the pulse duration may be less than about 10 picoseconds.

The at least one temporal characteristic may include a pulse duration. The substrate may be a silicon substrate, the wavelength may be less than 400 nm, and the pulse duration may be less than about 10 picoseconds. The step of generating may be at least partially carried out with a UV mode-locked laser.

The step of generating may be carried out using a MOPA. The temporal shape of each of the laser pulses may be at least partially substantially square with a rise time of about 2 nanoseconds or less.

The settling time may be 0.5 milliseconds or less.

Further in carrying out the above object and other objects of the present invention, a system for high-speed, precise, laser-based modification of at least one electrical element to adjust a measurable parameter is provided. The at least one electrical element includes a target material supported on a substrate. The system includes a laser susystem that generates a pulsed laser output that has one or more laser pulses at a repetition rate. Each laser pulse has a pulse energy, a laser wavelength, and at least one temporal characteristic that sufficiently reduces an ablation threshold energy density of the target material to avoid both substantial spurious opto-electric effects in a non-target material and undesirable damage to the non-target material. The system further includes a beam positioner that selectively irradiates the at least one electrical element with the one or more laser pulses focused into at least one spot so as to cause the one or more laser pulses having the wavelength, energy and the at least one temporal characteristic to selectively modify a physical property of the target material of the at least one electrical element while avoiding both substantial spurious opto-electric effects in the non-target material and undesirable damage to the non-target material.

The one or more focused laser pulses may selectively ablate a portion of the target material and the wavelength may be within a range of ablation sensitivity of at least the target material.

The at least one temporal characteristic may include a pulse duration and the ablation threshold energy density may decrease with reduced pulse duration.

The at least one electrical element may be operatively connected to an electronic device having the measurable parameter. The system may further include an electrical input for activating at least a portion of the device and a detector for measuring a value of the measurable parameter after generation of the one or more laser pulses.

The at least one temporal characteristic may include a pulse duration of about 25 femtoseconds or greater.

The at least one temporal characteristic may include a substantially square pulse shape, and each laser pulse may have a duration less than about 10 nanoseconds.

The target and non-target material may both be supported on the substrate, the substrate being a non-target substrate having a substrate ablation energy density threshold.

Each laser pulse may have a duration greater than 25 femtoseconds and less than about 10 nanoseconds.

The laser-based modification may be laser trimming. The system may further include means for comparing an actual value of the parameter with a preselected value for the parameter, and means for determining whether the target material requires additional irradiating with the laser output to satisfy the preselected value for the parameter of the device.

The target material may form part of a target structure and the non-target material may comprise a material of the substrate which supports the target structure. The non-target material may include at least one of silicon, germanium, indium gallium arsenide, semiconductor and ceramic material and the target material may include at least one of aluminum, titanium, nickel, copper, tungsten, platinum, gold, nickel, chromide, tantalum nitride, titanium nitride, cesium silicide, doped polysilicon, disilicide, and polycide.

The non-target material may comprise a portion of an electronic structure adjacent the target material.

The adjacent electronic structure may comprise a semiconductor material-based substrate or a ceramic substrate.

The target material may form part of a thin film resistor, a capacitor, an inductor, or an active device.

The target material may form part of an active device which may include at least one conductive link, and the active device may be adjusted, at least in part, by removing the at least one conductive link.

The target material or the non-target material may comprise a portion of a photo-electric sensing component.

The photo-electric sensing component may comprise a photodiode or a CCD.

The device may be an opto-electric device and the target material or the non-target material may comprise a portion of the opto-electric device. The device may include a photo-sensing element and an amplifier operatively coupled to the photo-sensing element, and the laser wavelength may be in a region of high quantum efficiency of the photo-sensing element, whereby the size of the at least one spot may be reducible compared to a spot size produced at a wavelength greater than 1 μm.

The photo-sensing element and the amplifier may be an integrated assembly. The system may further include means for generating an optical measurement signal and means for directing the measurement signal along a path having a common portion with a path of the one or more laser pulses.

The means for determining may determine substantially instantaneously subsequent to irradiating by the beam positioner.

There may be substantially no device settling time between irradiating by the beam positioner and measuring by the detector.

The at least one electrical element may include one or more elements having substantially different optical properties. The laser subsystem may include a master oscillator and power amplifier (MOPA). The master oscillator may include a semiconductor laser diode and a computer operatively coupled to the laser diode. The computer may be programmed to apply a signal to the laser diode to control the at least one temporal characteristic so as to selectively modify the physical property of the target material.

The at least one temporal characteristic may include a pulse duration. The substrate may be a silicon substrate, the wavelength may be less than 1.6 μm, and the pulse duration may be less than about 100 picoseconds.

The wavelength may be about 1.55 jam, and the laser subsystem may include an Erbium-doped, fiber amplifier and a seed laser diode. Opto-electronic sensitivity may be below a detection limit of equipment which measures an operational parameter associated with the at least one electrical element, whereby the useful dynamic range of a resistance measurement may be limited by the maximum dynamic range of the equipment.

The at least one temporal characteristic may include a pulse duration. The substrate may be a silicon substrate, the wavelength may be less than 800 nm, and the pulse duration may be less than about 100 picoseconds.

The at least one temporal characteristic may include a pulse duration. The substrate may be a silicon substrate, the wavelength may be less than 550 nm, and the pulse duration may be less than about 10 picoseconds.

The at least one temporal characteristic may include a pulse duration. The substrate may be a silicon substrate, the wavelength may be less than 400 nm, and the pulse duration may be less than about 10 picoseconds. The laser subsystem may be a UV mode-locked laser.

The laser subsystem may have a MOPA configuration. The temporal shape of each of the laser pulses may be substantially square with a rise time of about 2 nanoseconds or less.

The settling time may be 0.5 milliseconds or less.

The laser subsystem may include a fiber laser or a disk laser.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1a illustrates the operation and results obtained with various conventional functional trimming systems that utilize IR laser outputs; FIG. 1a is a top plan view, partially broken away, of a portion of an integrated circuit depicting resistors having a resistive film path between metal contacts; FIG. 1b is a block diagram of a prior art automated dynamic-trim system and device under test; FIG. 1c is a simplified schematic diagram of a multiplier cell the +Y input is switched between a specified +voltage pair while a trimming laser increases the resistance of either R1 or R2, wherein FIGS. 1b and 1c correspond to FIGS. 3 and 4, respectively, of chapter 3 of the handbook entitled “Nonlinear Circuits Handbook” published by Analog Devices Inc. in 1976; FIG. 1d is a top schematic view, partially broken away, of a die of a semiconductor wafer; there are thin film resistance elements as well as metal links (i.e., copper, gold or Al etc.) on the die; another possible combination of devices to be processed would include thick film-based devices;

FIG. 2 is a graph which illustrates the relation between the minimum relative energy required for trimming as a function of pulse width;

FIGS. 3a-3d are graphs which illustrate a relationship of absorption and photoelectric response for certain semiconductor materials, and also the absorption of certain materials over a wide wavelength range; the graph of FIG. 3a is taken from FIG. 9.7 of Moss, “Optical Properties of Semiconductors” and illustrates spectral response of silicon containing boron and indium; FIG. 3b is taken from U.S. Pat. No. 4,399,345 to Lapham, et al. and illustrates absorption of silicon as a function of wavelength; the graphs of FIG. 3c show typical responsivity curves of silicon and indium gallium arsenide-based detectors versus wavelength as illustrated in the '995 and '272 patents; FIG. 3d is taken from the publication of Liu, et al. (hereinbelow) and illustrates the effect of wavelength and doping concentration on the damage threshold of Si, with 150 fs pulses;

FIG. 4a is a top plan schematic view of a conventional laser trim with a relatively large HAZ; FIG. 4b is a top plan schematic view of an exemplary ultra-fast laser trim with little or no HAZ; FIG. 4c is a combined graph and side view of a resistor which illustrates a kerf size and profile to be obtained with an embodiment of the present invention; a focused laser spot and a pulse width sub-diffraction limited kerf size are shown;

FIG. 5a is an example of a sequence of laser material processing pulses;

FIG. 5b is an enlarged graph of power (y-axis) versus time (x-axis) for one of the laser material processing pulses of FIG. 5a generated in accordance with one embodiment of the present invention;

FIG. 6 is a schematic block diagram illustrating a system corresponding to an one embodiment of the invention;

FIG. 7 schematically illustrates a system corresponding to another embodiment of the present invention; (the system may include a short wavelength mode-locked or fiber laser having a pulse width of a one picosecond or less);

FIGS. 8a-8b are oscilloscope traces; the trace of FIG. 8a shows an output voltage of a typical voltage regulator device undergoing laser functional processing in accordance with one embodiment of the present invention; laser output pulses with ultrashort pulse width may be directed at a resistor of an activated voltage regulator; the straight line of the oscilloscope trace of FIG. 8b depicts the output voltage of the voltage regulator and shows no momentary dips in output voltage; therefore, measurements can be made immediately after laser impingement, or at any time before or after laser impingement to obtain a true measurement value of the output voltage;

FIG. 9a is a schematic diagram illustrating an exemplary photodetection/amplifier device which may be both trimmed and measured in accordance with the present invention; and

FIGS. 9b and 9c illustrate systems for trimming and testing the device of FIG. 9a.

### DETAILED DESCRIPTION OF THE PREFERRED EMBODIMENTS

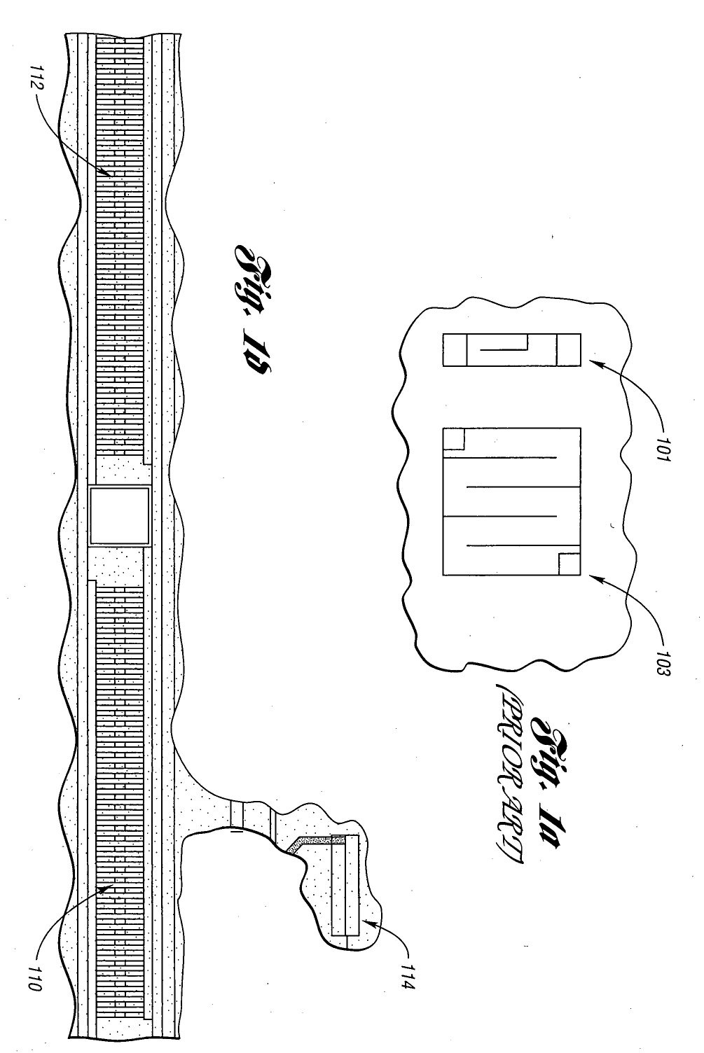

As previously mentioned, several aspects of laser trimming are discussed in the “LIA Handbook of Laser Material Processing” (hereinafter “Handbook”), 2002, Chapter 17, “Trimming,” pages 583-588. Included therein is a discussion of the basics of laser trimming, and techniques for thick film trimming, thin film on ceramic, chip resistor trimming, and trimming of thin film resistors on silicon. The handbook disclosed that a pulse duration shorter than 100 ns is used to cause the material to heat and rapidly vaporize. By way of example, FIG. 1a of the present application shows a typical serpentine cut on a resistor, an example of a trim that provides for a high value change, at relatively slow trim speed, and with relatively poor stability. Other shapes are shown in Table I of the Handbook.

As noted in the handbook, laser trimming systems are used primarily by the electronics industry to remove material of to “trim” components (usually resistors) of a circuit to some specified condition. Such systems generally include a laser, movement mechanism(s) to move the laser beam relative substrate, a control system coupled to a computer, and measurement system. Viewing and parts handling may be available. The present disclosure makes frequent reference to “trimming”, and the term is to be construed broadly. Embodiments of the present invention are regarded as generally applicable to systems providing laser-based adjustment by micromachining one or electrical elements, and the electrical elements may be part of any type of an electrical circuit, for instance an element of a MEMs device. Measurable parameters may include electrical parameters, for example at least one of resistance, capacitance, and inductance. In some embodiments, other physical parameters may be measured, for example temperature, pressure, or fluid flow.

Circuit adjustment, for example laser trimming, of certain active devices may also include removal of links of a ladder network to adjust resistance in discrete steps. The conductive links may include high conductivity metals, for instance copper or gold.

The active devices include but are not limited to amplifiers, regulators, photonic devices, and signal processing components. FIG. 1d shows a portion of such a device to be trimmed using a system of the present invention. The device may contain include active components which may be adjusted in discrete steps and miniature thin film resistors to trimmed with precision to a fraction of a percent, with other circuit components in close proximity. It is desirable to adjust the circuits of the substrate and to reduce or avoid any dependence of trim precision and post-trim stability on material characteristics of geometry.

Various embodiments of the present invention provide for improved trim precision, improved post trim stability, avoidance of substrate damage, and reduction or effective elimination any spurious photoelectric response. These benefits are generally to be obtained while simultaneously providing for a smaller spot size and kerf-width control.

Embodiments of the present invention generally provide for laser trimming of active devices having materials with opto-electronic sensitivity. The device may be supported on a substrate of semiconductive or non-conductive material. The laser system for trimming may be used to adjust thick film resistors, capacitors, inductors. In some embodiments conductive links made of a metal, for instance gold or copper, may be disconnected to adjust a circuit. A preferred laser system will be able to process any combination of the above target materials with a single laser system.

It is known that the energy required to ablate target material (for a given spot size) generally decreases with decreasing pulse width. For example, the required energy may decrease as the square root of the pulse width, down to a pulse width of about 10 picoseconds. For example, if 100 μJ is required for ablation with a typical 100 ns pulse for trimming, then about 1 μJ is required with a 10 picosecond (ps) pulse. At pulse widths shorter than 10 picoseconds the relationship between energy and pulse width may vary with material type (e.g: dielectrics, conductors, semiconductors).

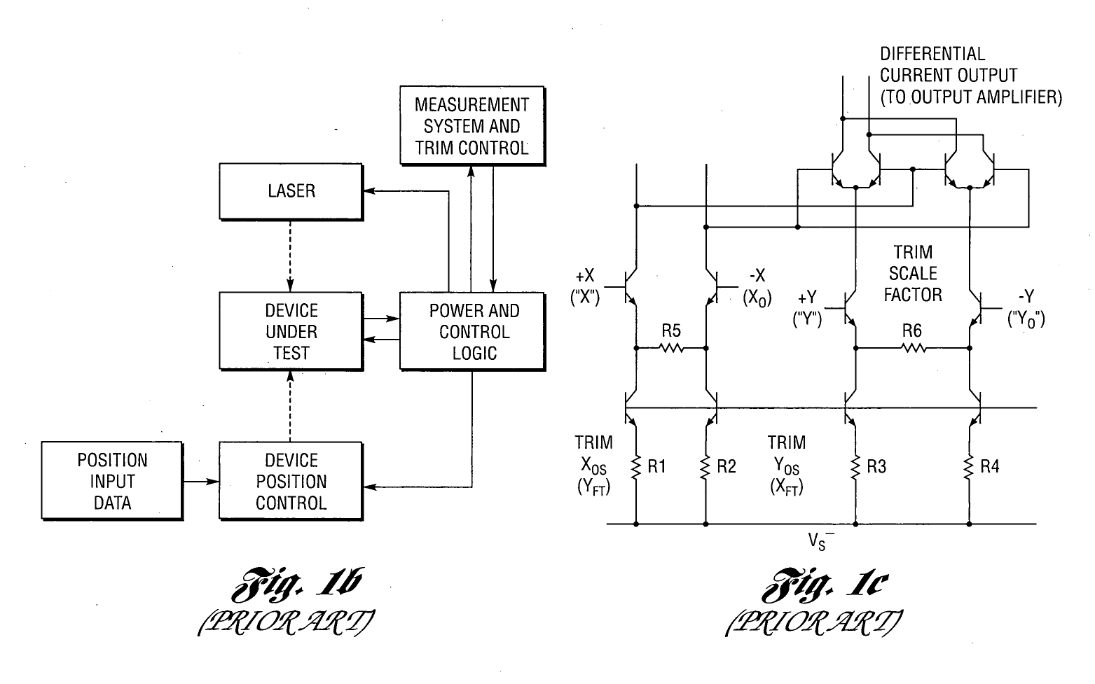

FIG. 2 illustrates a relation between the minimum relative energy required for trimming as a function of pulse width.

In some embodiments of the present invention an ultrashort laser may be used for the trimming at 1.064 μm wavelength, or at an alternative decreased near IR, visible or UV wavelength. In at least one embodiment a picosecond or nanosecond shaped-pulse laser may be utilized. For smaller spot size, one can choose the decreased wavelength such that it gives practical minimum limit. Further, as will be discussed later, certain benefits may also be achieved at longer wavelengths, for example 1.55 μm wherein a larger spot size is acceptable.

The reduction in energy with decreasing pulse width alone will significantly reduce the amount of energy required for the adjustment process. However, the number of carriers N (and therefore, the induced current) generated due to the laser light will also be reduced. Although it is not necessary to the practice of embodiments of the present invention to understand an operative mechanism therein, applicant believes the excess carriers N that could be generated in silicon illuminated by laser light can be estimated to be proportional to the following factors: 1) energy density (E) on the silicon; 2) the fraction of incident light coupled into the silicon (A); and 3) the wavelength dependent absorption coefficient (α); and 4) inversely proportional to the light photon energy (hu).

N˜[A*E*α(λ)]/ν

### Therefore, with N proportional to the energy density, and assuming the square-root relation, the number of carriers N is therefore also proportional to the square root of the laser pulse width Δτ.

N˜(Δτ)^{1/2}

For example, the photoelectric current induced by a 10 ps laser pulse having the lower energy is only 1.4% of what induced by a 50 ns laser pulse and 3.4% by a 7 ns laser pulse, respectively.

A further related benefit of substantially reducing the pulse width is the shallow depth of the light penetration beyond the trim area. The thermal diffusion dimensions are proportional to the square root of the laser pulse width. Photon-excitation effects will be confined to much smaller dimensions compared to that which results from a long pulse width of conventional q-switched trimming laser (wherein the typical pulse width is in the tens of ns to hundreds of ns). Device elements located outside the affected region will receive negligible induced current with the use of a sufficiently short pulse of relatively low energy. The reduced opto-electric current reduces the settling time for trimming which could be 0.5 ms or less. Furthermore, the reduced settling time can increase the pulse repetition rate, up to the measurement limit, at which the trimming is carried out.

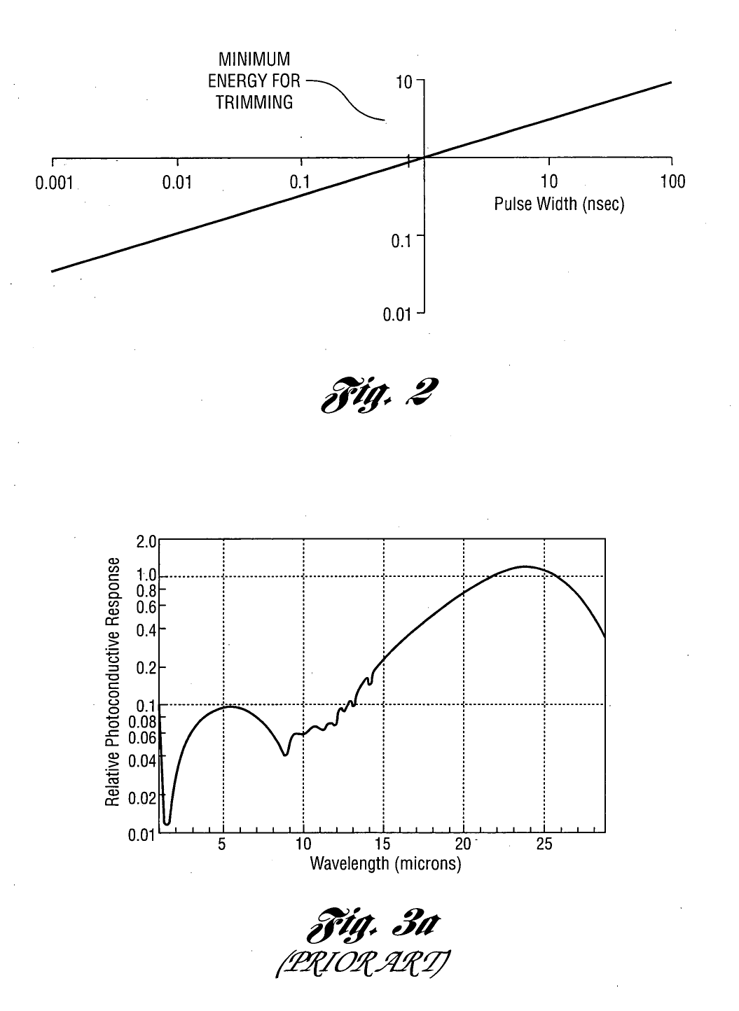

The wavelength sensitivity of the photoelectric response can vary greatly. FIGS. 3a (adapted from Moss, “Optical Properties of Semiconductors” and 3b (from U.S. Pat. No. 4,399,345, “Lapham”) show the wavelength sensitive absorption and photo-response characteristics on a logarithmic scale. FIGS. 3c and 3d exemplify typical responsivity curves of photosensitive devices, on a linear scale (adapted from the '995 patent and the '726 patent). These published graphs broadly and collectively illustrate inherent relationship of absorption and photoelectric response for certain semiconductor materials over a wide range of wavelengths.

By way of example, it can be shown that the absorption of silicon is a minima at about 1.2 μm, with a rapid increase of greater than one order of magnitude at conventional wavelengths of 1.064 μm and 1.047 μm.

Although the most common substrate material is silicon, embodiments of the present invention may be applied to target material on germanium, InGaAs, or other semiconductive substrates.

Further examination of the above-noted silicon spectral curves shows greatly increased absorption at shorter wavelengths. When trimming certain devices, where the substrate is exposed to shorter wavelength laser pulses, substrate damage may occur.

Further reductions in pulse widths, for example to the range of 100 fs-10 ps, may mitigate this effect. By way of example, the publication of Liu et al., “Effects of Wavelength and Doping Concentration on Silicon Damage Threshold,” and, in particular, FIG. 2 thereof, shows the dependence of the silicon damage threshold on doping concentration and wavelength. The result is shown in FIG. 3b herein. The threshold fluence shows only about a 5:1 variation over a wavelength range of 0.8-2.2 μm. The pulse width was fixed at 150 fs. Non-linear absorption at the 150 fs ultrashort pulse width and corresponding high peak power may explain the reduced dependence.

As evident from FIGS. 3a-3c, in the corresponding wavelength range there are several orders of magnitude increase in (linear) absorption. It is also evident that the most rapid changes occur within this approximate range, and that Si absorption curves are relatively flat in the UV and visible ranges, exhibiting a metal-like characteristic at the short wavelength. Hence, reliable short wavelength operation is possible provided the energy density of a laser pulse is low enough so as to avoid substrate damage while being high enough to ablate target material.

In accordance with the square-root approximation, if the pulse width is decreased from 100 ns to 10 ps then the number of carriers will be reduced by about one-hundred fold, thereby providing for operation at the shorter wavelengths with some margin. Whereas the teachings of the cited '995, '272, and '726 patent documents generally teach operation in a region of low absorption and low quantum efficiency of silicon, operation in accordance with at least an aspect of the present invention is expected to decrease the wavelength sensitivity and associated limitations.

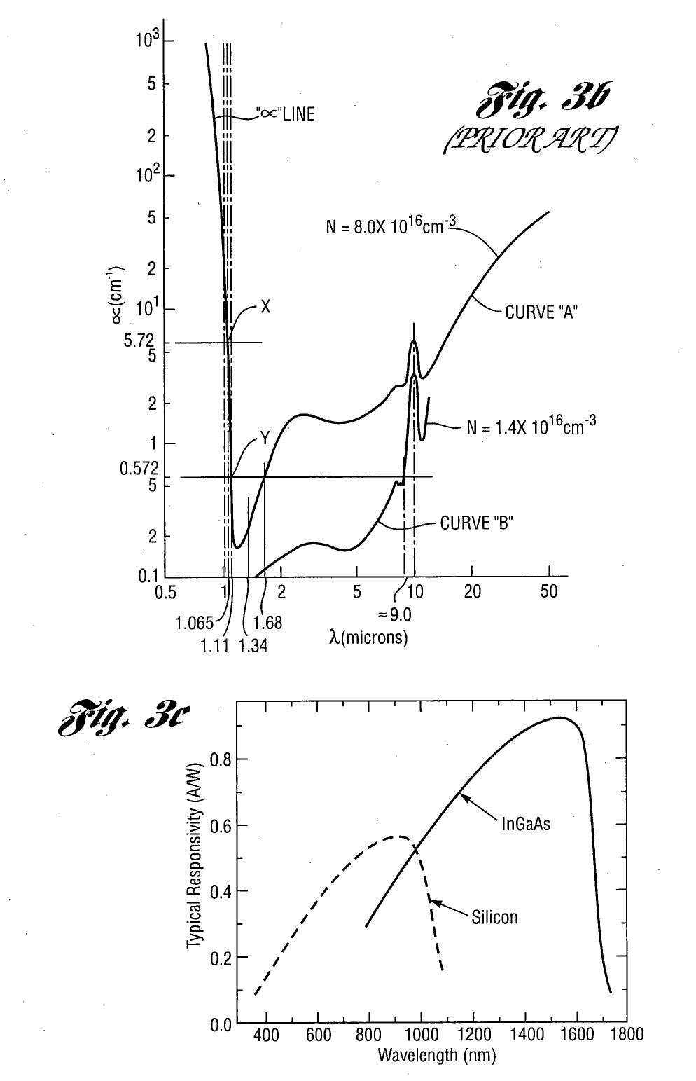

Shorter laser pulses, for instance pulses in the range of 1 ps to 100 ps, provide for shallow depth of the light penetration beyond the trim area. This would reduce the observable photon-excitation effects over much smaller dimensions. FIGS. 4a and 4b illustrate a portion of a device, and the area affected with the impinging laser output as a function of pulse width, FIG. 4a corresponding to a relatively long pulse.

Ultrashort laser pulses of appropriate energy density may be used to create a “threshold ablation effect” which results in effective spot sizes smaller than that of diffraction limited as disclosed in U.S. Pat. No. 5,656,186 to Mourou et al. The thresholding effect is further illustrated in FIG. 4c. Therefore, for the same wavelength used, the ultrashort laser can have smaller kerf compared to conventional q-switched lasers.

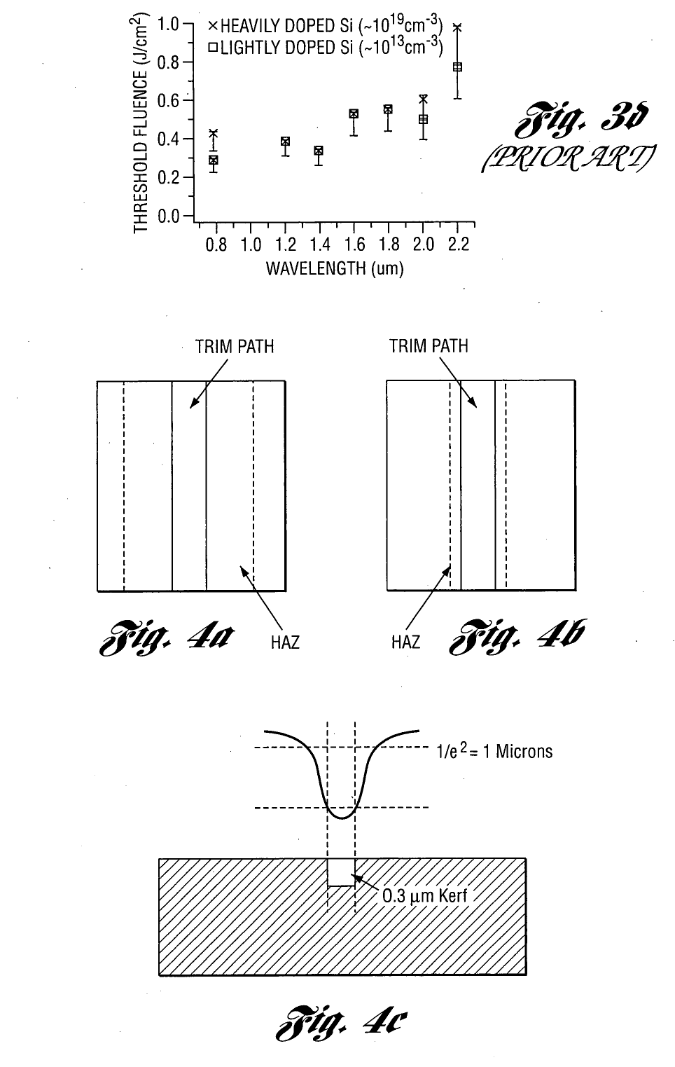

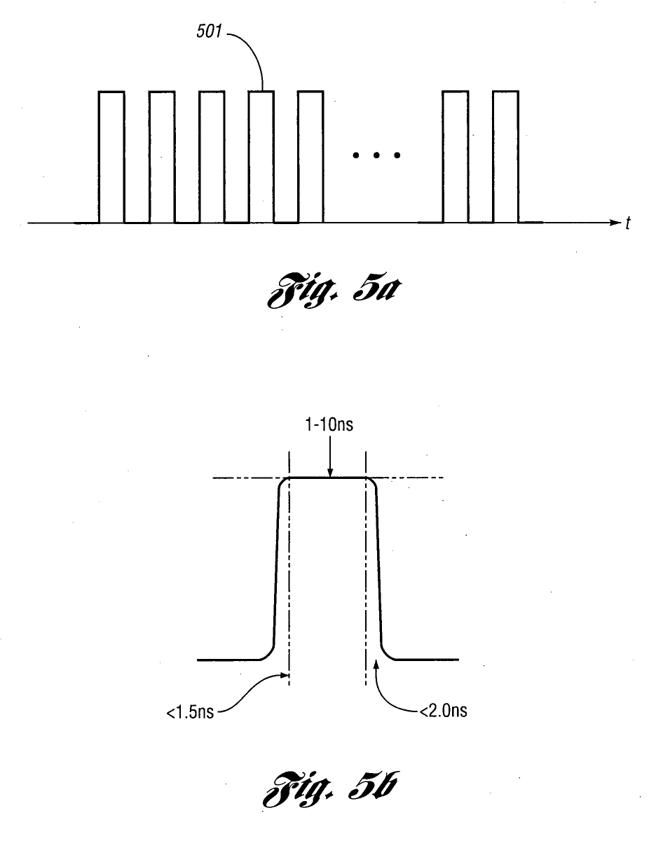

In at least one embodiment, a fast rise/fast fall pulse characteristic laser may be utilized. An exemplary pulse shape is shown in FIG. 5b, which is an enlarged graph of a pulse taken from the pulse train of FIG. 5a. The preferred pulse width will again be substantially reduced compared to a conventional trim pulse widths, particularly for processing a device having photoelectric sensitivity. Such a device may be replicated on a wafer, or may be part of a microelectronic assembly having various thin film resistors and other active devices, some of which may have opto-electronic sensitivity at various wavelengths, from UV to IR.

A square pulse gives rise to more efficient process by better coupling the laser energy into the material. Unlike conventional q-switched pulse shapes, a fast fall time prevents excess energy from a tail from impinging the material. Therefore, less energy is needed for the trimming process.

A typical pulse width may be in the range of a few picoseconds to several nanoseconds, depending upon specific material processing requirements and goals.

A conventional wavelength may be utilized. Alternatively, in at least one embodiment, a wavelength shifter may be utilized to increase the wavelength. For example, the square pulse may be generated at a conventional 1.064 wavelength and wavelength shifted to a longer wavelength. In a preferred embodiment, a seed laser and fiber optic amplifier may be used, as disclosed in U.S. Pat. No. 6,340,806, entitled “Energy-Efficient Method and System for Processing Target Material Using an Amplified, Wavelength Shifted Pulse Train.” The application of the specific longer wavelength embodiment is generally limited by the spot size requirement, although wavelength shifting from a first wavelength to a second longer wavelength is not restricted to IR wavelengths.

In another embodiment, harmonic generator(s) may be used to produce a short wavelength near IR, visible, or UV output. One example of a wavelength shifted finer laser system is provided in U.S. Pat. No. 6,275,250, entitled “Fiber Gain Medium Marking System Pumped or Seeded by a Modulated Laser Diode Source and Method of Energy Control.” FIG. 10 and associated text of the '250 patent disclose a fiber-based MOPA device having an output wavelength of 545 nm, corresponding a frequency doubling of a 1090 nm seed diode.

The optimum pulse width may be found for each trimming application. If the laser pulse width can be adjusted easily, one may significantly improve the process window. It is also desirable to have the pulse width tunable so that the optimum coupling can be found, thus, minimum energy required can be found, therefore, the reduced photoelectric effect achieved. Published PCT application WO 98/42050, and U.S. Pat. Nos. 6,727,458; 5,867,305; 5,818,630; and 5,400,350 exemplify various laser diode-based configurations. The teachings of these patent documents may be used alone or in combination to produce suitable pulse widths, repetition rates, and pulse shapes. The GSI Group Inc. Model M-430 memory repair equipment and M320 memory repair system included seed diode/fiber amplifier configurations. The recently announced M350 trimming system is configurable to a MOPA laser system architecture.

An aspect of at least one embodiment of the invention is to improve the post-trim stability by reducing or eliminating the heat-affected zone (HAZ) along the trim path, as shown in FIG. 4b. Either a fast rise/fall, pulse-shaped, q-switched laser, or an ultrashort laser may be used. Furthermore, less residual energy left for the neighboring zone near the trim path—thus less heat affect zone (HAZ) is generated. A fast rise/fall, pulse-shaped laser may be used for trimming to generally reduce the post-trim drift caused by the HAZ along the trim path of various types of devices.

Similarly, a suitable combination of pulse-shaping and ultrashort laser technologies may also be preferable for certain demanding applications.

In at least one embodiment a beam-shaping optic may be used to generate a flat-top beam profile to reduce the HAZ along the trim path.

When the pulse width of the laser is reduced, the thermally affected area, indicated by the thermal diffusion length is shortened. It has been shown that the diffusion length is proportional to the square root of the laser pulse width when the process is mainly thermal in nature. When the pulse duration is less that of the electron-photon interaction time constant, which is roughly a few pico-seconds depending on the specific material, the interaction becomes non-thermal in nature. The HAZ in this case will be eliminated. Ultrashort lasers may be used for trimming to reduce or eliminate the post trim drift caused by the HAZ along the trim path, as shown in FIG. 4b.

Further improvement may result with spatial-beam shaping, wherein the laser beam is transformed from a conventional Gaussian to a flat-top (i.e., FIG. 5b). This may reduce the spot size for trimming, thus reduce or eliminate the energy in the tail portion of the Gaussian beam, which is one of the main causes for heating up the surrounding area along the trim path. Because of the less energy left outside the trim kerf, less HAZ will be produced for the same total energy. A spatially-shaped beam, preferably flat-top, may be used for trimming to reduce the post-trim drift caused by the HAZ along the trim path.

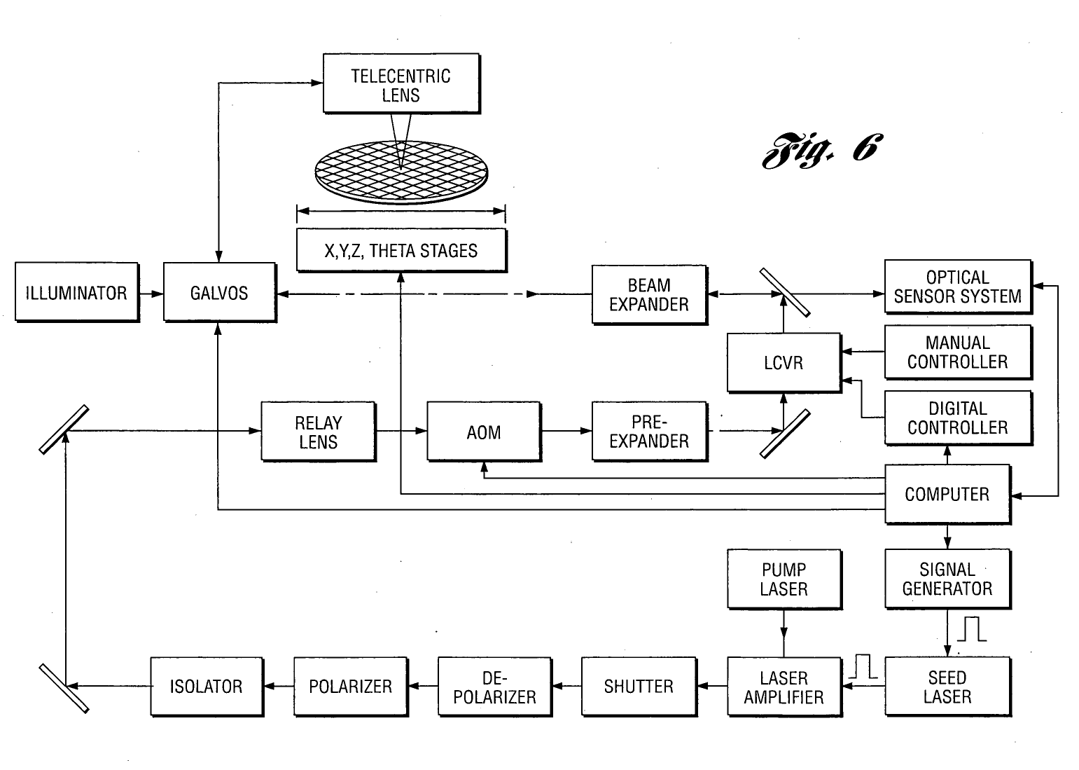

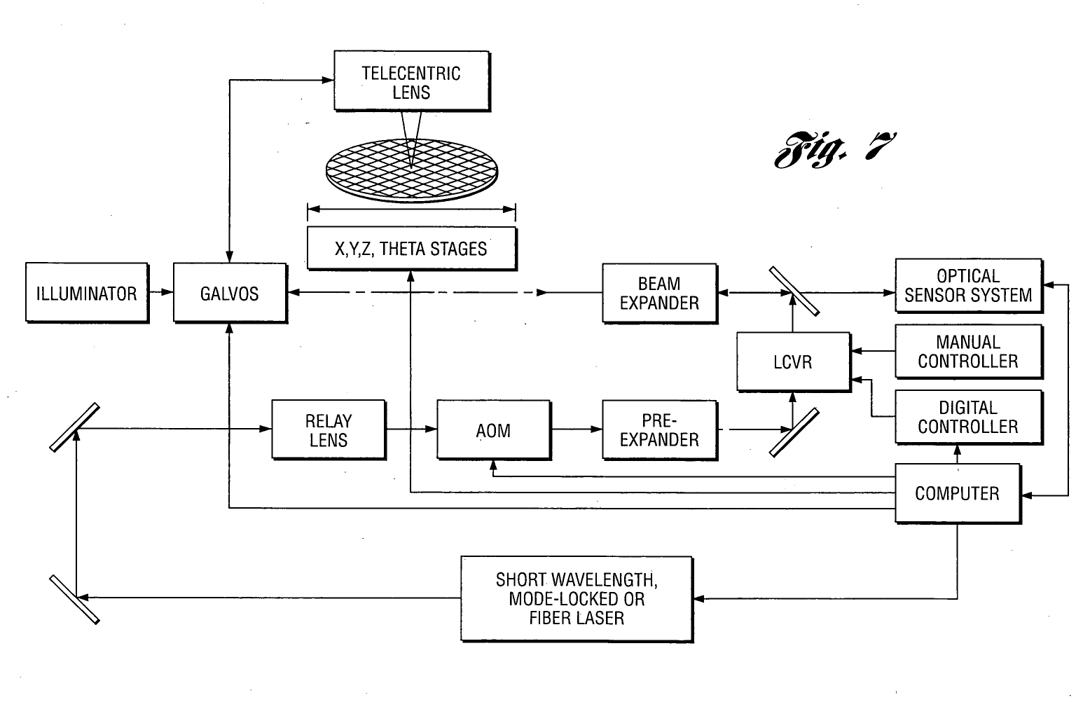

FIG. 6 illustrates several components of a complete laser trimming system. In the embodiment of FIG. 6, a MOPA configuration is shown having a semiconductor seed laser and fiber optic amplifier, as exemplified in U.S. Pat. No. 6,727,458, assigned to the assignee of the present invention (i.e., FIGS. 5 and 7). A square pulse, for instance having a pulse width in the range of several picoseconds (ps) to about 10 nanoseconds (ns), is typically generated. Other pulse shapes, for example, a sawtooth, are disclosed. A semiconductor seed diode provides for direct modulation and adjustment of various pulse characteristics, for instance the pulse width. The wavelength may be an IR wavelength

The system of FIG. 6 also includes a conventional shutter, a de-polarizer, a polarizer, an isolator (to prevent back reflection), mirrors, a beam splitter, a relay lens, an AOM (acousto optic modulator) and a pre-expander, all of which are well known in the art and are disclosed in numerous patents which describe fiber lasers.

The system of FIG. 6 also includes an AC voltage-controlled, liquid crystal variable retarder (LCVR) and mount. The LCVR includes a birefringent liquid crystal sandwiched between two plates. As is known in the art, the birefringent liquid crystal can rotate the polarization of a laser beam, because light moves at different speeds along different axes through the birefringent liquid crystal, resulting in a phase shift of the polarization. Here, the LCVR rotates the linearly polarized beam so that one can have any linearly polarized beam on the target (links) with polarization parallel or perpendicular to link length orientation. Moreover, the birefringent liquid crystal can also transform the linearly polarized laser input into an elliptically or circularly polarized laser output. The laser beam maintains its polarization as it travels from the LCVR to the work surface of the die to be processed.

The voltage applied to the liquid crystal variable retarder is controlled by a digital controller and/or a manual controller, which interfaces with the liquid crystal variable retarder through a cable. The manual controller can be adjusted by a user in order to vary the voltage to the LCVR based on the user's knowledge of whether a link to be destroyed or blown is vertical or horizontal, for example. The digital controller receives inputs from the computer in order to automatically vary the voltage to LCVR based on information stored in the computer pertaining to the alignment of the links to be cut. This input from the computer controls the digital controller so as to cause an appropriate voltage to be applied to the LCVR. The correct voltages to achieve horizontal polarization, vertical polarization, circular polarization, etc. can be determined experimentally.

In one embodiment, the digital controller is programmed to select among three different voltages corresponding to vertical linear polarization, horizontal linear polarization, and circular polarization. In other embodiments, the digital controller stores different voltages, including voltages corresponding to various elliptical polarizations. Other embodiments are also possible in which the liquid crystal variable retarder is capable of rotating linear polarization to numerous angles other than the vertical or the horizontal, in the event that polarization at such angles proves useful for cutting or trimming certain types of structures.

The system of FIG. 6 also includes a subsystem for delivering a focused beam to the targets on a single die of a semiconductor wafer. The laser beam positioning mechanism preferably includes a pair of mirrors and attached respective galvanometers (i.e., various galvos available from the assignee of the present application). The beam positioning mechanism directs the laser beam through a lens (which may be telecentric or non-telecentric). The X-Y galvanometer mirror system may provide angular coverage of the entire wafer if sufficient precision is maintained. Otherwise, various positioning mechanisms may be used to provide relative motion between the wafer and the laser beam. For instance, a two-axis precision step and repeat translator may be used to position the wafer galvanometer based mirror system (e.g., in the X-Y plane). The laser beam positioning mechanism moves the laser beam long two perpendicular axes, thereby providing two dimensional positioning of the laser beam across the wafer region. Each mirror and associated galvanometer moves the beam along its respective x or y axis under control of the computer.

The beam positioning subsystem may include other optical components, such as a computer-controlled, optical subsystem for adjusting the laser spot size and/or automatic focusing of the laser spot at a location of the die of the wafer.

The system of FIG. 6 may also include an optical sensor system to determine the end of a laser adjustment process. In one embodiment, an optical sensor of the system may include a camera (as described in the '9354 publication) which operates in combination with an illuminator as shown in FIG. 6. In another embodiment, the optical sensor of the system includes a single photo detector wherein a laser pulse is attenuated by the AOM and the attenuated pulse is sensed by the photo detector after being reflected back from the die. In yet another embodiment, a low power laser (not shown in FIG. 6 but shown in FIG. 13 of the '7581 publication and described in the corresponding portion of its specification) can be used for optical inspection or detection purposes.

FIG. 7 illustrates an alternative embodiment wherein a green or UV mode-locked laser, or a fiber laser is utilized. Such a UV mode-locked laser system is exemplified in the U.S. Pat. No. 6,210,401, entitled “Method of, and Apparatus for, Surgery of the Cornea.” Although primarily directed to laser surgery, the it was disclosed that the invention can also be useful for application in micro-electronics in the areas of circuit repair, mask fabrication and repair, and direct writing of circuits. FIGS. 11-18 and the associated text disclose the laser system. The generated laser pulses may have widths of about 10 ps or shorter.

FIG. 5a illustrates a burst of pulses for trimming that may be generated from either the MOPA or mode-locked laser. In addition, multiple pulses can be used to fully take advantage of ultrashort laser processing, or at other reduced pulse widths. The high repetition rates available from mode-locked lasers or MOPA fiber configurations will generally provide for rapid throughput. The throughput may be limited by the vapor/plasma/plume from previous pulse interactions with the target material. The laser energy contributing to the substrate damage can be dramatically reduced, almost by a factor of N, where N is the number of the pulses in a burst of pulses for trimming. This is especially advantageous when the laser is used for trimming by blowing fuse links, as is discussed hereinbelow.

Furthermore, other picosecond and femtosecond lasers may be used in various embodiments of the present invention. For example, the laser types disclosed in FIGS. 1-8 and the corresponding text of U.S. Pat. No. 6,979,798, entitled “Laser System and Method for Material Processing with Ultrafast Lasers,” as well as FIGS. 6a-8e and the corresponding text of published U.S. patent application 2004/0134896 entitled “Laser-based Method and System for Memory Link Processing with Picosecond Lasers” may be used. Generally, fiber-based systems are preferred for use in embodiments utilizing shaped-pulses or ultrashort pulses.

The following laser types may also be used (as disclosed in the '9354 publication):
1. Q-switched thin disk laser. Such a laser can generate short pulses in the ns range (typical 1-30 ns) and has all of the advantages of a disk laser. An example of a resonator design based on a disk laser is illustrated in FIG. 18 and corresponding text of the '9354 publication. The design includes a mirror (HR, R=5000 mm), Yb: YAG disk on heat sink, a mirror (HR, R=−33000 mm), an AOM and element (T=10%, plane). In this example, crystal thickness is 150 μm, pumped diameter is 2.2 mm and cavity length is 840 mm.
2. Regenerative thin disk amplifier. A typical system configuration is shown in FIG. 20 of the '9354 publication and comprises:
   a) a seed-laser including a thin disk pump module, a Lyot-Filter, an etalon, an output coupler and an optimal isolator;
   b) a pulse slicer including a λ/2 plate, a Pockels cell and a TFP;
   c) a pair of mirrors;
   d) an input-output separation module or unit including a mirror, a TFP, a detector which detects an output beam, a λ/2 plate and a Faraday isolator; and
   e) a regenerative amplifier including a TFP, mirrors, a thin disk pump module, an end mirror, a λ/4 plate, a Pockels cell and an end mirror.
3. Disk-based ultrashort laser. An example is Yb:YAG passively mode-locking oscillator which will give 16.2 watts with a 730 fs pulse width at 34.6 MHZ and described in OPTICS LETTERS, 25, 859 (2000). Another example is a thin disk regenerative amplifier such as illustrated in FIG. 19 of the '9354 publication. A seed laser may be used as the master oscillator which could be a disk laser itself as described immediately above or other type of ultrashort laser source. This arrangement gives high pulse energy at ultrashort pulse widths. An example of a thin disk regenerative amplifier is shown in FIG. 19 of the '9354 publication and comprises:
   a) the master oscillator;
   b) mirrors;
   c) a separation module or unit including a polarizer, a detector for detecting an output beam from the polarizer, a Faraday rotator and a λ/2 plate; and
   d) a resonator unit or module including a thin disk mounted on a heat sink, mirrors, a polarizer, a λ/4 plate, a Pockels cell and a mirror.

When an ultra-short pulse propagates through a transparent medium, such as a window or even air, it will get stretched in time due to the dispersion of the material. When focusing ultra-broadband femtosecond pulses, the compensation of the dispersion of the lenses should be provided in order to get the best solution to focus ultra-short pulses to a small and undistorted spot size. The ability to control dispersion effects is significantly important for all applications requiring ultra-short (femtosecond) laser pulses. Therefore, optical elements in the beam delivery subsystem have to be carefully designed and chosen in order to have minimal phase distortion and therefore optimum dispersion performance. These dispersion-compensated or controlled optical elements, e.g., turning mirrors, beam splitters, lenses, prisms, etc., are commercially available. One such supplier is Femtolasers Produktions GmbH, Vienna, Austria.

Embodiments of the present invention may be utilized in various trimming operations: thick/thin film, for trimming active devices, and generally for trimming devices with circuit elements arranged at fine spacings. The device, surrounding circuitry, or substrate may exhibit significant opto-electronic sensitivity.

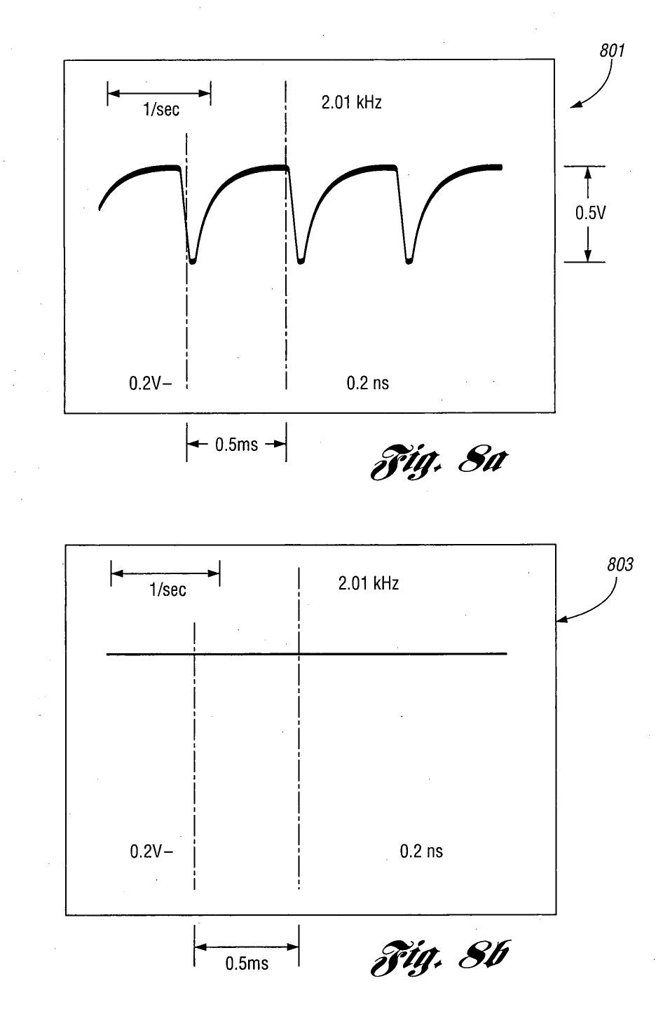

By way of example, FIG. 8a is a schematic oscilloscope trace showing momentary dips in the output voltage of a device having opto-electronic sensitivity and undergoing prior art functional laser processing, for instance with a 1.047 or 1.064 laser. With reference to FIG. 8b, laser output pulses at the wavelength of 1.32 μm at 2.01 KHz were directed at a resistor of an activated voltage regulator as disclosed in the '995 patent (substantially identical to the voltage regulator previously discussed). FIG. 8b is a schematic oscilloscope trace showing an output voltage of a typical voltage regulator device to be processed in accordance with the present invention. Laser output pulses with ultrashort pulse width or suitable short pulses from a shaped-pulse laser are to be directed at a resistor of the activated device. The straight line of the oscilloscope trace of FIG. 8b depicting the output voltage of the voltage regulator shows no momentary dips in output voltage as a result of negligible opt-electronic response.

Therefore, as in the case for processing with a 1.32 um laser, measurements may be made immediately after laser impingement, or at any time before or after laser impingement to obtain a true measurement value of the output voltage. However, in accordance with an embodiment of the present invention, the performance is to be obtained at shorter wavelengths wherein the laser spot size is much smaller and therefore suitable for production of smaller kerf sizes and for laser processing at a finer scale.

Moreover, as with operation at 1.32 μm as disclosed in the '995 patent, laser output pulses can be applied at shorter intervals, i.e., at a higher repetition rate, because no recovery time is required before measurements can be obtained. Thus, much higher processing throughput can be realized. These benefits may be achieved with embodiments of the present invention, but with smaller spot sizes than achievable at 1.32 μm or similar wavelengths.

A similar result expected for functional processing in accordance with the present invention includes laser trimming of a frequency band-pass filter to within its frequency response specification, photodetector circuits, and various active signal processing circuits and devices.

For example, the cell of FIG. 1c (but at finer scale with circuit dimensions and spacings decreased) may be processed.

Another use of at least one embodiment of the present invention is to trim a resistor of an activated A/D or D/A converter to achieve output with specified conversion accuracy. Resistance may be adjusted by forming a kerf in a thick film resistor, by removing links of a ladder network, or both.

Referring again to FIG. 1d for yet another example, an adjustable pulse-shaped laser may be used to trim a portion of a die of a semiconductor wafer having numerous circuit elements formed thereon. The circuit elements include a bank 110 of 2 micron gold links and a bank 112 of 2 micron copper links as well as a SiCr, tantalum nitride or NiCr thin film resistive element 114, any of which can be processed with the method and system of at least one embodiment of the present invention. In this example, the circuit was adjusted by blowing the links. Thin film resistors were also trimmed. The pulse width was adjustable, and typical pulse widths of 10-20 ns were used.

In each example described above, a reduced wavelength laser output is to be utilized, for instance 1.12 μm, 1.064 μm, 0.7-0.8 μm, visible, or ultraviolet wavelengths. The lower laser pulse energy associated with the shorter pulse width is to at least balance the effect of lower silicon absorption at 1.32 μm or other wavelengths beyond the absorption edge of silicon.

As disclosed in the '9354 publication, a spot for laser trimming may have a non-uniform intensity profile along a direction and a spot diameter less than about 15 microns. A range of about 6-15 microns is preferred for trimming many thin film devices.

In some embodiments, a smaller spot size may be used to adjust a device, either with formation of reduced kerf on a miniature device, or by disconnecting links of a ladder network.

For instance, a 4-6 μm spot size may be suitable for certain trimming applications. Further performance improvements may be achieved with a combination of a laser wavelength having an exceedingly low substrate transmission and a short pulse width, perhaps a ultrashort pulse width. By way of example, the substrate may be silicon, the laser wavelength may be 1.55 μm, and the pulse width may be in a range from about 1 picosecond to a few nanoseconds. A fiber-based MOPA approach is preferred and is particularly well suited for operation at 1.55 μm wavelengths (a standard telecommunication wavelength).

In such a long wavelength arrangement, the dynamic performance (including bandwidth and dynamic range) may be limited by resistance measurement equipment, with no detectable delays caused by the photoelectric effect. The spurious output may be below a detection limit (“noise floor”) of the measurement equipment, and difficult if not impossible to detect. The useful dynamic range of the resistance measurement may be limited by the maximum dynamic range of the equipment. For instance, if FIG. 8b were illustrated at an expanded logarithmic scale no spurious low-level signal would be detected.

Yet another example is an extension of earlier detector trimming and test as disclosed in the '726 patent publication. The '726 patent publication generally teaches operating at a trim wavelength where the quantum efficiency is exceedingly low. In accordance with the present invention, the trimming laser wavelength may also be in a range of high quantum efficiency of the photodetector, though not necessarily required. The trimming wavelength may generally be in a range where the absorption is weaker, for instance a near IR trimming in the range of greater than about 700 nm, but less than the absorption edge of silicon.

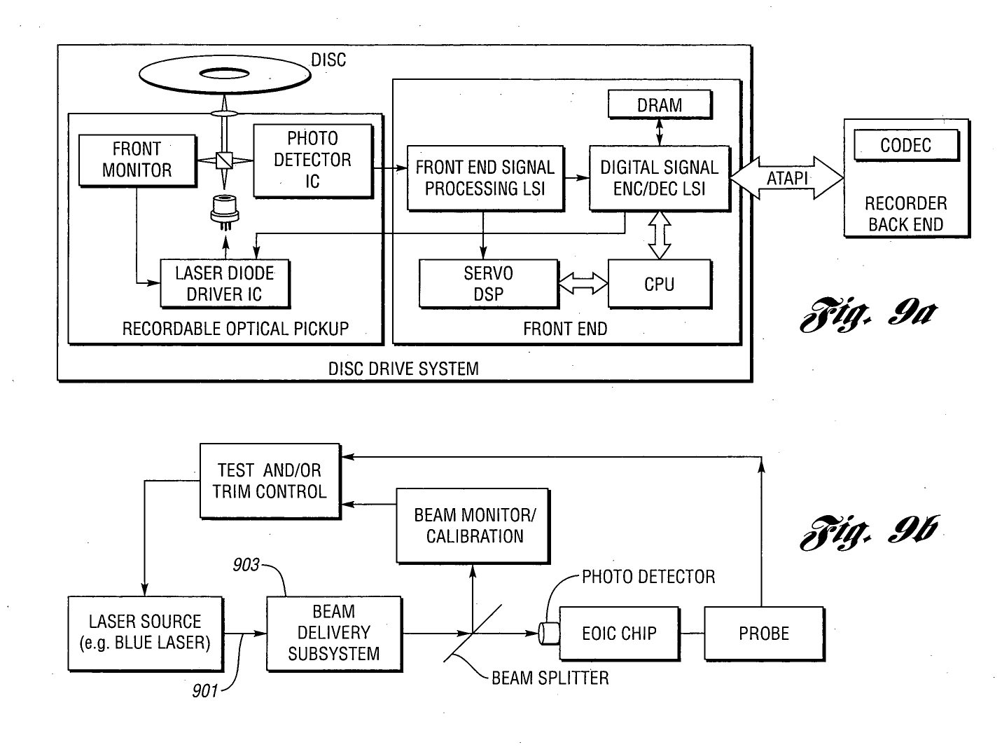

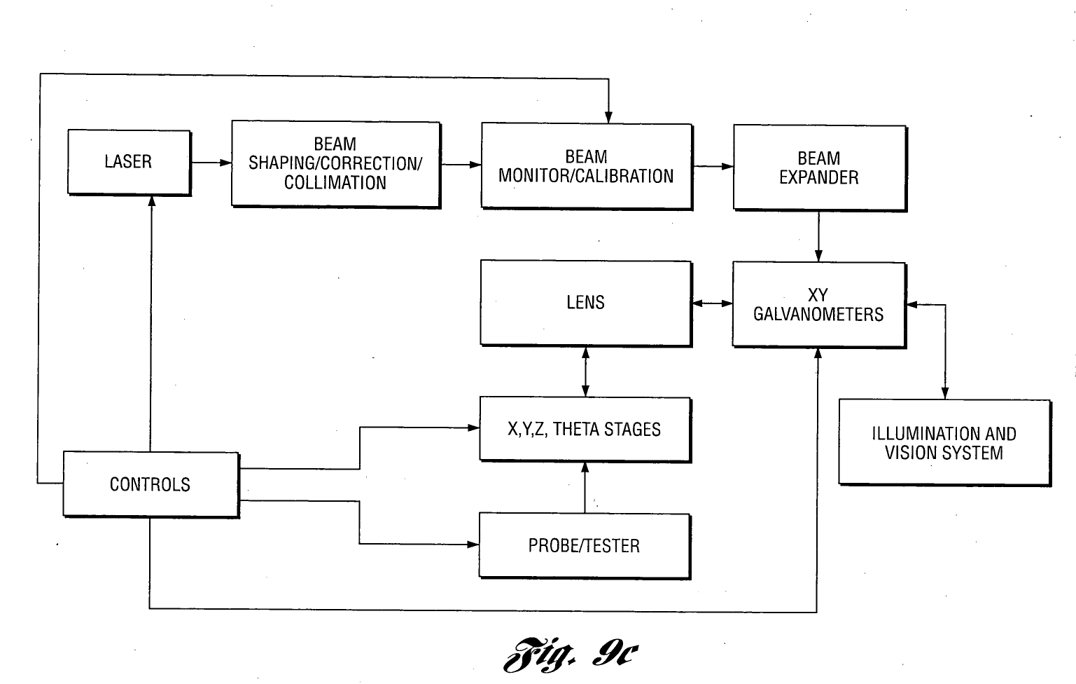

As circuit and other dimensions shrink, embodiments of the present invention may provide for yet increased benefits. By way of example, FIG. 9a illustrates a detector/amplifier combination which is to be a part of a miniature integrated circuit (opto-electronic integrated circuit, OEIC). Such a photoreceiver integrated circuit (shown as photodetector IC) may be used in compact disk (CD), digital video disk (DVD), and, eventually, high definition DVD technology (HD-DVD). Fabrication of these chips requires not only trimming the circuit to a target value but testing and calibrating the output characteristics of the circuit with the specific light source. Such light sources are typically laser diodes with 780 nm, 650 nm, or 405 nm wavelengths, the latter being a wavelength used for High Definition DVD technology (e.g.: Blue-Ray™ HD/DVD. Preferably, a single trimming machine can be used for all trim, calibration, and test operations.

Referring to FIG. 9b, in an exemplary embodiment of the invention, a blue laser source delivers measurement light 901 to the photodetector through beam delivery subsystem 903 at a calibrated power level. A beam monitor/calibration module monitors at least the power and/or an output of the laser and may also incorporate other components to monitor various laser spatial and temporal characteristics. The test and/or trim control module, which is interfaced to a system computer (not shown), determines whether trimming is required, monitors the operation, and determines whether the output of the detector (and possibly an on-board amplifier) conforms with a specification. In one embodiment the detector may be activated with a short wavelength region (e.g., blue green) of high quantum efficiency. Various components of the circuit may then be trimmed as required using a short wavelength (also in a region of high quantum efficiency) with potential reduction in kerf width (and therefore support for further miniaturization).

By way of example, and in contrast to the '726 patent publication, and '995 patent teachings, and with reference to FIGS. 9a, 9b, and 9c, herein, the photodetector may be photodiode, such as a quadrant cell, that has enhanced sensitivity at short visible wavelengths (e.g., 400-450 nm). With an increased trend toward waferscale integration, the photodiode may be on a silicon substrate. Additionally, the detector may be configured with at least a portion of its amplifier circuitry in close proximity. A measurement beam may be generated using a 405 nm blue laser diode output. Trimming at a fine scale may be carried out with a green laser having an ultrashort pulse width, or possibly a 355 nm ultrashort laser. Preferably, the pulse width will be less than or on the order of 1 picosecond to several hundred picoseconds to avoid wavelength-sensitive absorption in non-target material.

FIG. 9c shows additional components of another embodiment of a system of the invention, wherein several components are in common with those of FIG. 6 and/or otherwise disclosed herein. Preferably, a common beam delivery subsystem is used for both measurement and trimming operations.

Use of a short wavelength for both measurement and trimming wavelengths may alleviate at least some optical design challenges in producing small spot sizes, for instance spot sizes on the order of a visible laser wavelength. Delivery of the measurement beam and trimming beam energy through the common optical subsystem of FIG. 9c is preferred, as opposed to separate optical subsystems optimized for respective wavelengths.

The design of such laser systems for processing some devices may generally include use of a-priori information. For instance a model of the materials of a multi-material device may be used. Further, precise control of laser energy characteristics, and control of the focused spot shape and the three dimensional location of laser beam impingement may be used in certain embodiments of the present invention. U.S. Pat. Nos. 6,573,473 entitled “Method and System for Precisely Positioning a Waist of a Material Processing Beam to Process Microstructures Within a Laser Processing Site,” 6,949,844 entitled “High Speed Precision Positioning Apparatus,” and 6,777,645 entitled “High Speed Precision Laser-Based Method and System for Processing One or More Targets With a Field” are assigned to the assignee of the present invention. The disclosures teach numerous methods of spot shaping (i.e., well focused round and non-round spots) and precise positioning of laser beams in three dimensions, including laser beams having spot sizes on the order of one micron.

In some embodiments of the present invention, an ultrashort laser having a pulse width as long as possible is to be utilized. The choice will minimize expense and the number of optical components required, for instance, grating compressors and stretchers. For instance, a pulse width of about 50 picoseconds may be suitable for use in certain short-wavelength embodiments. However, with continuing development of ultrashort technology, various embodiments utilizing sub-picosecond technology may provide for commercial realization of femtosecond technology in production environments where systems operate continuously (i.e.: 24 hrs. per day, 7 days per week).

The illustrative embodiments herein may be combined in various ways without departing from the scope of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of high-speed, precise, laser-based modification of at least one electrical element to adjust a measurable parameter, the at least one electrical element comprising a target material, and being supported on a substrate, the method comprising:
generating a pulsed laser output having one or more laser pulses at a repetition rate, each laser pulse having a pulse energy, a laser wavelength, and at least one temporal characteristic that sufficiently reduces an ablation threshold energy density of the target material to avoid both substantial spurious opto-electric effects in a non-target material and undesirable damage to the non-target material; and
selectively irradiating the at least one electrical element with the one or more laser pulses focused into at least one spot so as to cause the one or more laser pulses having the wavelength, energy and the at least one temporal characteristic to selectively modify a physical property of the target material of the at least one electrical element while avoiding both the substantial spurious opto-electric effects in the non-target material and undesirable damage to the non-target material.

2. The method of claim 1, wherein the step of irradiating selectively ablates a portion of the target material and the wavelength is within a range of ablation sensitivity of at least the target material.

3. The method of claim 1, wherein the at least one temporal characteristic includes a pulse duration and wherein the ablation threshold energy density decreases with reduced pulse duration.

4. The method as claimed in claim 1, wherein the at least one electrical element is operatively connected to an electronic device having the measurable parameter, and wherein the method further comprises:
activating at least a portion of the device; and
measuring a value of the measurable parameter either during or after the step of generating.

5. The method of claim 1, wherein the at least one temporal characteristic includes a pulse duration of about 25 femtoseconds or greater.

6. The method of claim 1, wherein the at least one temporal characteristic includes a substantially square pulse shape, and wherein each laser pulse has a duration less than about 10 nanoseconds.

7. The method of claim 1, wherein the target and non-target material are both supported on the substrate, the substrate being a non-target substrate having a substrate ablation energy density threshold.

8. The method of claim 1, wherein each laser pulse has a duration greater than 25 femtoseconds and less than about 10 nanoseconds.

9. The method of claim 4, wherein the laser-based modification is laser trimming, and wherein the method further comprises:
comparing an actual value of the parameter with a preselected value for the parameter; and
determining whether the target material requires additional irradiating with the laser output to satisfy the preselected value for the parameter of the device.

10. The method of claim 1, wherein the target material forms part of a target structure and the non-target material comprises a material of the substrate which supports the target structure, and wherein the non-target material comprises at least one of silicon, germanium, indium gallium arsenide, semiconductor and ceramic material and the target material comprises at least one of aluminum, titanium, nickel, copper, tungsten, platinum, gold, nickel, chromide, tantalum nitride, titanium nitride, cesium silicide, doped polysilicon, disilicide, and polycide.

11. The method of claim 1, wherein the non-target material comprises a portion of an electronic structure adjacent the target material.

12. The method of claim 11, wherein the adjacent electronic structure comprises a semiconductor material-based substrate or a ceramic substrate.

13. The method of claim 1, wherein the target material forms part of a thin film resistor, a capacitor, an inductor, an integrated circuit, or an active device.

14. The method of claim 1, wherein target material forms part of an active device which includes at least one conductive link, and wherein the device is adjusted, at least in part, by removing the at least one conductive link by performing the steps of generating and irradiating.

15. The method of claim 1, wherein the target material or the non-target material comprises a portion of a photo-electric sensing component.

16. The method of claim 15, wherein the photo-electric sensing component comprises a photodiode or a CCD.

17. The method of claim 4, wherein the device is an opto-electric device and the target material or the non-target material comprises a portion of the opto-electric device, the device including a photo-sensing element and an amplifier operatively coupled to the photo-sensing element, and wherein the laser wavelength is in a region of high quantum efficiency of the photo-sensing element, whereby the size of the at least one spot is reducible compared to a spot size produced at a wavelength greater than 1 μm.

18. The method of claim 17, wherein the photo-sensing element and the amplifier are an integrated assembly, and wherein the method further comprises:
generating an optical measurement signal; and
directing the measurement signal along a path having a common portion with a path of the one or more laser pulses.

19. The method of claim 9, wherein the step of determining is performed substantially instantaneously subsequent to the step of irradiating.

20. The method of claim 4, wherein there is substantially no device settling time between the steps of irradiating and measuring.

21. The method of claim 14, wherein the at least one electrical element includes one or more elements having substantially different optical properties, wherein the step of generating is carried out with a master-oscillator and power amplifier (MOPA), the master oscillator including a semiconductor laser diode; and wherein the method further comprises: applying a signal to the laser diode to control the at least one temporal characteristic so as to selectively modify the physical property of the target material.

22. The method of claim 1, wherein the at least one temporal characteristic includes a pulse duration, wherein the substrate is a silicon substrate, wherein the wavelength is less than 1.6 μm, and wherein the pulse duration is less than about 100 picoseconds.

23. The method of claim 1, wherein the wavelength is about 1.55 μm, wherein the step of generating is at least partially carried out with an Erbium-doped, fiber amplifier and a seed laser diode, wherein opto-electronic sensitivity is below a detection limit of equipment which measures an operational parameter associated with the at least one element, whereby the useful dynamic range of a measurement is limited by the maximum dynamic range of the equipment.

24. The method of claim 1, wherein the at least one temporal characteristic includes a pulse duration, wherein the substrate is a silicon substrate, wherein the wavelength is less than 800 nm, and wherein the pulse duration is less than about 100 picoseconds.

25. The method of claim 1, wherein the at least one temporal characteristic includes a pulse duration, wherein the substrate is a silicon substrate, wherein the wavelength is less than 550 nm, and wherein the pulse duration is less than about 10 picoseconds.

26. The method of claim 1, wherein the at least one temporal characteristic includes pulse duration, wherein the substrate is a silicon substrate, wherein the wavelength is less than 400 nm, wherein the pulse duration is less than about 10 picoseconds, and wherein the step of generating is at least partially carried out with a UV mode-locked laser.

27. The method of claim 1, wherein the step of generating is at least partially carried out using a MOPA, and wherein temporal shape of each of the laser pulses is substantially square with a rise time of about 2 nanoseconds or less.

28. The method of claim 20, wherein the settling time is 0.5 milliseconds or less.

29. A system for high-speed, precise, laser-based modification of at least one electrical element to adjust a measurable parameter, the at least one electrical element comprising a target material supported on a substrate, the system comprising:
a laser subsystem that generates a pulsed laser output having one or more laser pulses at a repetition rate, each laser pulse having a pulse energy, a laser wavelength, and at least one temporal characteristic that sufficiently reduces an ablation threshold energy density of the target material to avoid both substantial spurious opto-electric effects in the non-target material and undesirable damage to the non-target material; and
a beam positioner that selectively irradiates the at least one electrical element with the one or more laser pulses focused into at least one spot so as to cause the one or more laser pulses having the wavelength, energy and the at least one temporal characteristic to selectively modify a physical property of the target material of the at least one electrical element while avoiding both the substantial spurious opto-electric effects in the non-target material and undesirable damage to the non-target material.

30. The system of claim 29, wherein the one or more focused laser pulses selectively ablate a portion of the target material and the wavelength is within a range of ablation sensitivity of at least the target material.

31. The system of claim 29, wherein the at least one temporal characteristic includes a pulse duration and wherein the ablation threshold energy density decreases with reduced pulse duration.

32. The system as claimed in claim 29, wherein the at least one electrical element is operatively connected to an electronic device having the measurable parameter, and wherein the system further comprises:
an electrical input for activating at least a portion of the device; and
a detector for measuring a value of the measurable parameter after generation of the one or more laser pulses.

33. The system of claim 29, wherein the at least one temporal characteristic includes a pulse duration of about 25 femtoseconds or greater.

34. The system of claim 29, wherein the at least one temporal characteristic includes a substantially square pulse shape, and wherein each laser pulse has a duration less than about 10 nanoseconds.

35. The system of claim 29, wherein the target and non-target material are both supported on the substrate, the substrate being a non-target substrate having a substrate ablation energy density threshold.

36. The system of claim 29, wherein each laser pulse has a duration greater than 25 femtoseconds and less than about 10 nanoseconds.

37. The system of claim 32, wherein the laser-based modification is laser trimming, and wherein the system further comprises:
means for comparing an actual value of the parameter with a preselected value for the parameter; and
means for determining whether the target material requires additional irradiating with the laser output to satisfy the preselected value for the parameter of the device.

38. The system of claim 29, wherein the target material forms part of a target structure and the non-target material comprises a material of the substrate which supports the target structure, and wherein the non-target material comprises at least one of silicon, germanium, indium gallium arsenide, semiconductor and ceramic material and the target material comprises at least one of aluminum, titanium, nickel, copper, tungsten, platinum, gold, nickel, chromide, tantalum nitride, titanium nitride, cesium silicide, doped polysilicon, disilicide, and polycide.

39. The system of claim 29, wherein the non-target material comprises a portion of an electronic structure adjacent the target material.

40. The system of claim 39, wherein the adjacent electronic structure comprises a semiconductor material-based substrate or a ceramic substrate.

41. The system of claim 29, wherein the target material forms part of a thin film resistor, a capacitor, an inductor, or an active device.

42. The system of claim 29, wherein target material forms part of an active device which includes at least one conductive link, and wherein the active device is adjusted, at least in part, by removing the at least one conductive link.

43. The system of claim 29, wherein the target material or the non-target material comprises a portion of a photo-electric sensing component.

44. The system of claim 43, wherein the photo-electric sensing component comprises a photodiode or a CCD.

45. The system of claim 32, wherein the device is an opto-electric device and the target material or the non-target material comprises a portion of the opto-electric device, the device including a photo-sensing element and an amplifier operatively coupled to the photo-sensing element, and wherein the laser wavelength is in a region of high quantum efficiency of the photo-sensing element, whereby the size of the at least one spot is reducible compared to a spot size produced at a wavelength greater than 1 μm.

46. The system of claim 45, wherein the photo-sensing element and the amplifier are an integrated assembly, and wherein the system further comprises:
means for generating an optical measurement signal; and
means for directing the measurement signal along a path having a common portion with a path of the one or more laser pulses.

47. The system of claim 37, wherein the means for determining determines substantially instantaneously subsequent to irradiating by the beam positioner.

48. The system of claim 32, wherein there is substantially no device settling time between irradiating by the beam positioner and measuring by the detector.

49. The system of claim 29, wherein the at least one electrical element includes one or more elements having substantially different optical properties, and wherein the laser subsystem includes a master oscillator and power amplifier (MOPA), the master oscillator including a semiconductor laser diode; the system further comprising a computer operatively coupled to the laser diode, the computer being programmed to apply a signal to the laser diode to control the at least one temporal characteristic so as to selectively modify the physical property of the target material.

50. The system of claim 29, wherein the at least one temporal characteristic includes a pulse duration, wherein the substrate is a silicon substrate, wherein the wavelength is less than 1.6 μm, and wherein the pulse duration is less than about 100 picoseconds.

51. The system of claim 29, wherein the wavelength is about 1.55 μm, wherein the laser subsystem includes an Erbium-doped, fiber amplifier and a seed laser diode, wherein opto-electronic sensitivity is below a detection limit of equipment which measures an operational parameter associated with the at least one electrical element, whereby the useful dynamic range of a resistance measurement is limited by the maximum dynamic range of the equipment.

52. The system of claim 29, wherein the at least one temporal characteristic includes a pulse duration, wherein the substrate is a silicon substrate, wherein the wavelength is less than 800 nm, and wherein the pulse duration is less than about 100 picoseconds.

53. The system of claim 29, wherein the at least one temporal characteristic includes a pulse duration, wherein the substrate is a silicon substrate, wherein the wavelength is less than 550 nm, and wherein the pulse duration is less than about 10 picoseconds.

54. The system of claim 29, wherein the at least one temporal characteristic includes pulse duration, wherein the substrate is a silicon substrate, wherein the wavelength is less than 400 nm, wherein the pulse duration is less than about 10 picoseconds, and wherein the laser subsystem includes a UV mode-locked laser.

55. The system of claim 29, wherein the laser subsystem includes a MOPA configuration, and wherein temporal shape of each of the laser pulses is substantially square with a rise time of about 2 nanoseconds or less.

56. The system of claim 48, wherein the settling time is 0.5 milliseconds or less.

57. The system of claim 29, wherein the laser subsystem includes a fiber laser.

58. The system of claim 29, wherein the laser subsystem includes a disk laser.
